(19) United States
(12) Patent Application Publication
(10) Pub. No.: US 2025/0177997 A1
(43) Pub. Date: Jun. 5, 2025

(54) ELECTRIC PRECIPITATOR, AND HOME APPLIANCE COMPRISING SAME

(71) Applicant: LG ELECTRONICS INC., Seoul (KR)

(72) Inventor: Chulwoo PARK, Seoul (KR)

(21) Appl. No.: 18/842,472

(22) PCT Filed: Mar. 7, 2023
(86) PCT No.: PCT/KR2023/003098

§ 371 Date: Aug. 29, 2024

(30) Foreign Application Priority Data
Mar. 8, 2022 (KR) 10-2022-0029700

(51) Int. Cl. B03C 3/155; B03C 3/41; B03C 3/47; B03C 3/66

(52) U.S. Cl. CPC B03C 3/155; B03C 3/41; B03C 3/47; B03C 3/66

(57) ABSTRACT

The present disclosure relates to an electric precipitator and a home appliance including the same. An embodiment of the present disclosure includes: a first charging unit configured to charge particles; a dust collector disposed downstream of the first charging unit and configured to collect the charged particles; and a second charging unit configured to generate an alternating current between the first charging unit and the dust collector.

### TECHNICAL FIELD

The present disclosure relates to an electric precipitator, and more particularly, to an electric precipitator for improving the efficiency of collecting foreign substances in air.

### BACKGROUND ART

Generally, an electric precipitator is provided to remove foreign substances, such as dust and the like contained in air, by using a method of electrically charging and collecting the foreign substances. The electric precipitator may be used in the form of a filter, and may be mounted in home appliances, including an air purifier or an air conditioner such as a cooler or a heater, etc., to collect foreign substances, such as dust and the like, contained in air.

The foreign particles or particles harmful to the living body in air and the like are electrically charged while passing through the electric precipitator, so as to have a polarity, and the charged foreign particles may be collected through electrodes on the electric precipitator, a dielectric material or a filter, and the like.

Meanwhile, research is conducted on methods for improving the efficiency of collecting foreign substances in the electric precipitator.

Prior art document: Korean Patent No. 10-1474493 (registered on Dec. 12, 2014).

### DISCLOSURE OF INVENTION

### Technical Problem

It is an objective of the present disclosure to improve the efficiency of collecting foreign substances.

It is another objective of the present disclosure to reduce ozone generation.

The objectives of the present disclosure are not limited to the aforementioned objectives and other objectives not described herein will be clearly understood by those skilled in the art from the following description.

### Solution to Problem

In order to achieve the above objectives, an electric precipitator according to an embodiment of the present disclosure includes: a first charging unit configured to charge particles; a dust collector disposed downstream of the first charging unit and configured to collect the charged particles; and a second charging unit configured to generate an alternating current between the first charging unit and the dust collector.

According to an embodiment of the present disclosure, the second charging unit may be formed as a plurality of electrode plates elongated to one side and arranged parallel to each other in a thickness direction with a distance therebetween, and configured to generate the alternating current therebetween.

According to an embodiment of the present disclosure, the first charging unit may further include a case in which the second charging unit and the dust collector are accommodated, the case being open in an air flow direction.

According to an embodiment of the present disclosure, the first charging unit may be provided in plurality, the plurality of first charging units being disposed adjacent to an edge of the case and facing an opening of the case.

According to an embodiment of the present disclosure, the dust collector may include: a plurality of first electrodes to which a high voltage is applied; and a plurality of second electrodes which are arranged alternately with the first electrodes with a distance therebetween, and are grounded.

According to an embodiment of the present disclosure, at least one of the first electrode and the second electrode may include a needle electrode having a pointed shape for generating a corona discharge.

According to an embodiment of the present disclosure, the first electrode may be an electrically resistive metal and may be heated by receiving a voltage.

According to an embodiment of the present disclosure, the electric precipitator may further include a heater configured to heat air around the first electrode.

According to an embodiment of the present disclosure, the first electrode may be heated to 25 to 100 degrees Celsius.

According to an embodiment of the present disclosure, the dust collector may include a dielectric filter disposed downstream of the first electrode and the second electrode.

A home appliance according to an embodiment of the present disclosure includes the electric precipitator; a housing having an inlet and an outlet, the electric precipitator installed between the inlet and the outlet; and a blower fan disposed in the housing and configured to cause the air to flow from the inlet to the outlet.

Other detailed matters of the exemplary embodiments are included in the detailed description and the drawings.

### Advantageous Effects of Disclosure

The electric precipitator according to the present disclosure has one or more of the following effects.

First, the efficiency of collecting foreign substances may be improved.

Second, ozone generation may be reduced.

The effects of the present disclosure are not limited to the aforesaid, and other effects not described herein will be clearly understood by those skilled in the art from the following description of the appended claims.

### BRIEF DESCRIPTION OF DRAWINGS

FIG. 1 is an exploded view of a home appliance according to an embodiment of the present disclosure.

FIG. 2 is a perspective view of a plurality of electric precipitators coupled to a frame, according to an embodiment of the present disclosure.

FIG. 3 is a perspective view of an electric precipitator according to an embodiment of the present disclosure.

FIG. 4 is an exploded view of an internal configuration of an electric precipitator according to an embodiment of the present disclosure.

FIG. 5 is a cross-sectional view of the configuration of FIG. 4.

FIG. 6 is an exploded view of an internal configuration of an electric precipitator according to another embodiment of the present disclosure.

FIG. 7 is a cross-sectional view of the configuration of FIG. 6.

FIG. 8 is a diagram of foreign particles and ions ionized while passing through an electric precipitator.

FIG. 9 (a) illustrates a particle charging rate with respect to a relative ozone concentration in the case where only a diffusion charger or a wire-plate charger is used, and in the case where a second charging unit (alternating current charging) is added; and (b) illustrates dust collection efficiency of an electric precipitator including a diffusion charger and a dust collector, based on lengths of the dust collector of the electric precipitator in an air flow direction, and whether the second charging unit (alternating current charging) is added.

FIG. 10 is a diagram illustrating an example in which ozone is produced as oxygen in air is passed through a first electrode and a second electrode, and heat is applied to the ozone.

FIGS. 11 (a) and (b) are diagrams illustrating an ozone concentration which is reduced as electrodes are heated.

### MODE FOR THE INVENTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Spatially-relative terms such as “below”, “beneath”, “lower”, “above”, or “upper” may be used herein to describe one element's relationship to another element as illustrated in the Figures. It will be understood that spatially-relative terms are intended to encompass different orientations of the device in addition to the orientation depicted in the Figures. For example, if the device in one of the figures is turned over, elements described as “below” or “beneath” other elements would then be oriented “above” the other elements. The exemplary terms “below” or “beneath” can, therefore, encompass both an orientation of above and below. Since the device may be oriented in another direction, the spatially-relative terms may be interpreted in accordance with the orientation of the device.

The terminology used in the present disclosure is for the purpose of describing particular embodiments only and is not intended to limit the disclosure. As used in the disclosure and the appended claims, the singular forms are intended to include the plural forms as well, unless context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, the thickness or size of each layer is exaggerated, omitted, or schematically illustrated for convenience of description and clarity. Also, the size or area of each constituent element does not entirely reflect the actual size thereof.

Hereinafter, preferred embodiments of the present disclosure will be described with reference to the accompanying drawings.

Hereinafter, an electric precipitator and a home appliance including the same according to an embodiment of the present disclosure will be described with reference to embodiments of the present disclosure and the drawings illustrating the embodiments.

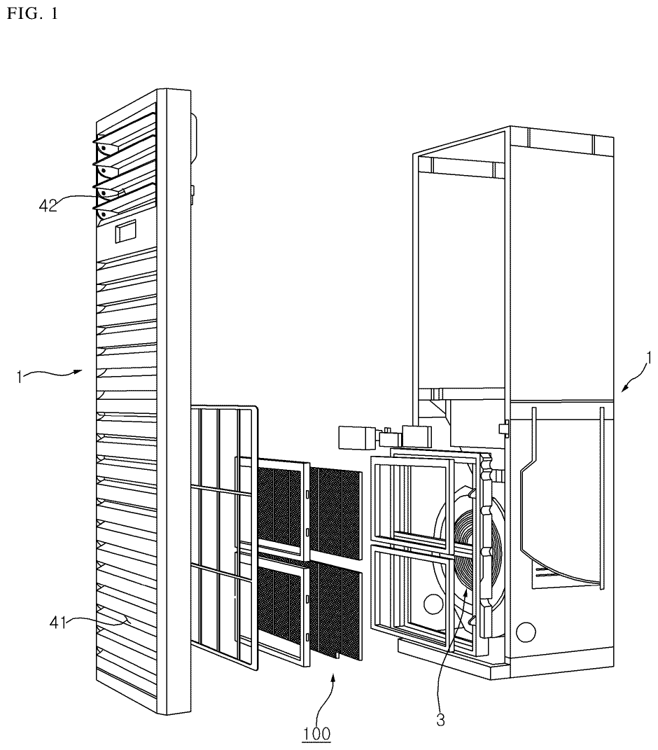

Referring to FIG. 1, a home appliance may be referred to as, for example, an air conditioner or an air purifier. The home appliance may include a housing 1. An electric precipitator 100 may be installed in the housing 1. The housing 1 may include an inlet 41 and an outlet 42. One side and another side of the housing 1 are open to form the inlet 41 and the outlet 42. For example, a front lower portion of the housing 1 may be open to form the inlet 41, and a front upper portion of the housing 1 may be open to form the outlet 42. A blower fan 3 may be disposed in the housing 1. The blower fan 3 may cause air to flow from the inlet 41 to the outlet 42.

The electric precipitator 100 may be disposed adjacent to the blower fan 3. The air introduced by the blower fan 3 through the inlet 41 may pass through the electric precipitator 100 to be discharged through the outlet 42 to the outside of the home appliance.

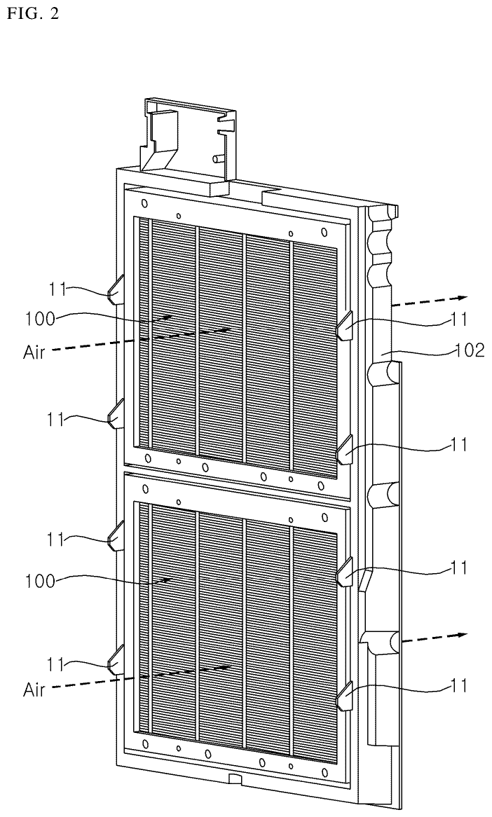

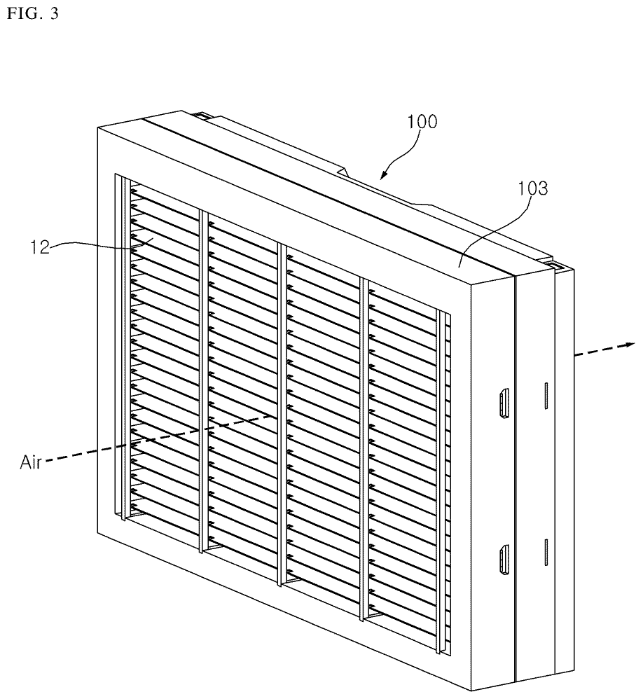

Referring to FIGS. 2 and 3, the electric precipitator 100 may include at least one electric dust collecting module 101. A plurality of electric dust collecting modules 101 may be fixed to a frame 102. For example, the plurality of electric dust collecting modules 101 may be disposed vertically parallel to each other.

A first charging unit 11 may charge particles. The first charging unit 11 may receive a high voltage. A plurality of first charging units 11 may be provided. The first charging unit 11 may be disposed adjacent to an edge of the electric precipitator 100. The first charging unit 11 may be disposed adjacent to an edge of a case 103. The first charging unit 11 may be installed at an edge of the frame 102. The first charging unit 11 may be a diffusion charger. Foreign particles contained in air may be charged and ionized while passing through the first charging unit 11. Foreign substances may include not only dust, but also other harmful substances or harmful microbes, and the like.

Referring to FIGS. 3 to 5, the case 103 may be open at the front and the rear. The case 103 may include a second charging unit 12 and a dust collector 20 provided therein. Air may pass through the case 103 by passing through the opening of the case 103.

The first charging unit 11 may be disposed at the front of the second charging unit 12. A plurality of first charging units 11 may be disposed at positions adjacent to each of both ends of the second charging unit 12. For example, four first charging units 11 may be disposed at positions respectively corresponding to a first end and a second end of the second charging unit 12. The first charging unit 11 disposed at one side and the first charging unit 11 disposed at another side may face each other and may be disposed to face a space in which air flows.

The second charging unit 12 may be disposed between the first charging unit 11 and the dust collector 20. The second charging unit 12 may generate an alternating current between the first charging unit 11 and the dust collector 20. Air may sequentially pass through the first charging unit 11, the second charging unit 12, and the dust collector 20.

The second charging unit 12 may be formed as a plurality of electrode plates which are elongated to one side. The second charging unit 12 may be referred to as an alternating current (AC) electrode 12. A plurality of second charging units 12 may be arranged parallel to an air flow direction. The plurality of second charging units 12 may be arranged parallel to each other in a thickness direction with a distance therebetween. Air may pass between the plurality of second charging units 12.

The dust collector 20 may be disposed downstream of the first charging unit 11 (see FIG. 2). The dust collector 20 may be disposed downstream of the second charging unit 12. The second charging unit 12 may be disposed between the first charging unit 11 and the dust collector 20. The dust collector 20 may collect charged particles.

The dust collector 20 may include a first electrode 21 and a second electrode 22. The first electrode 21 and the second electrode 22 may have an electrode plate shape which is elongated to one side. The first electrode 21 and the second electrode 22 may extend parallel to the second charging unit 12. Each of the first electrode 21 and the second electrode 22 may be provided in plurality. The plurality of first electrodes 21 and the plurality of second electrodes 22 may be alternately arranged parallel to each other in a thickness direction with a distance therebetween. The first electrode 21 and the second electrode 22 may face each other. Air may pass between the first electrode 21 and the second electrode 22.

The first electrode 21 may receive a high voltage. The second electrode 22 may be opposite to the first electrode 21. The second electrode 22 may be grounded. A high voltage may be applied so that a plasma is formed between the first electrode 21 and the second electrode 22.

The first electrode 21 and the second electrode 22 may have various arrangements and shapes. The first electrode 21 and the second electrode 22 may be arranged or formed so that plasma may be generated in a space therebetween and air may pass through the space, and are not limited to a specific arrangement or shape. The plasma may be generated as various types, such as corona discharge, dielectric barrier discharge, streamer discharge, arc discharge, etc., and electrode shapes or voltage shapes may be adopted according to the types.

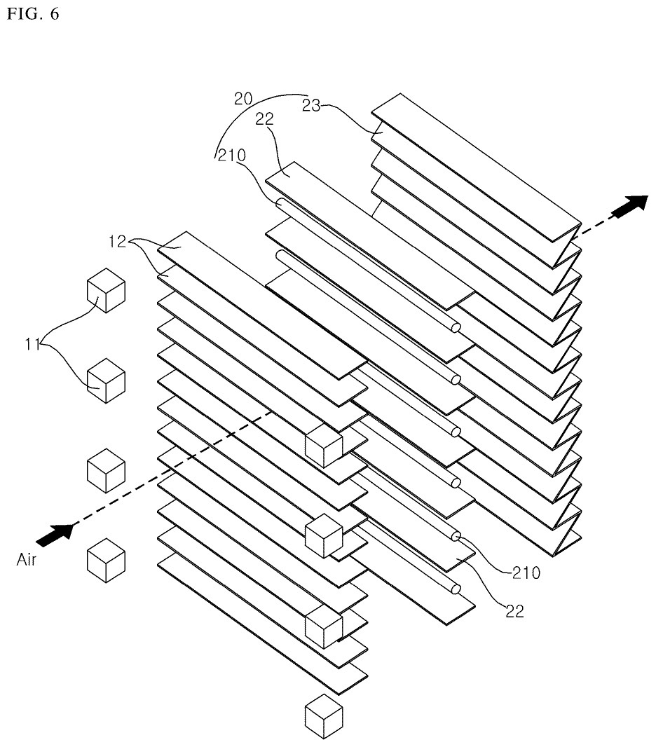

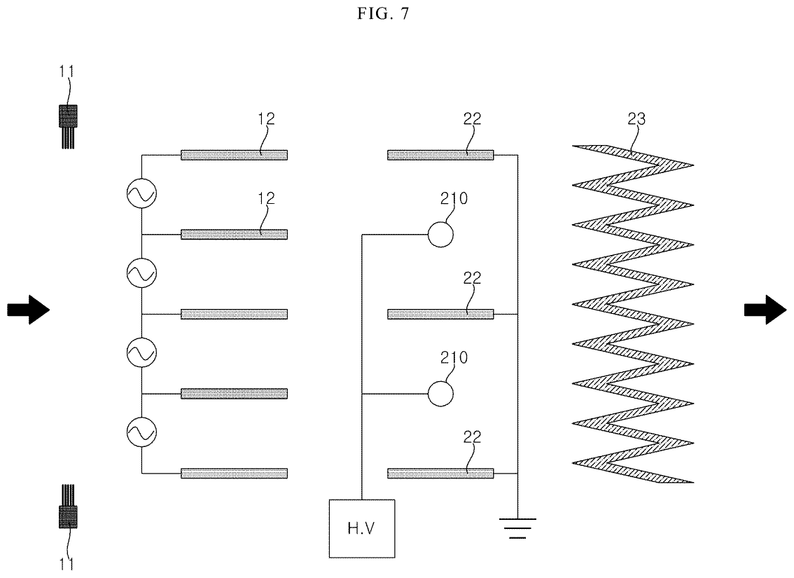

The first electrode 21 may include a needle electrode 21a having a pointed shape. If a high voltage is applied to the first electrode 21, corona discharge occurs at the needle electrode 21a. In another example, the needle electrode 21a may be formed on the second electrode 22. In another example, the first electrode 21 and the second electrode 22 may have a wire-plate shape (see FIGS. 6 and 7). Accordingly, foreign matter may be ionized.

The dust collector 20 may include a dielectric filter 23. The dielectric filter 23 may be formed of a porous filtration material such that air may pass therethrough. For example, the dielectric filter 23 may be a nonwoven fabric or a HEPA filter, and the like.

Meanwhile, the first electrode 21 and/or the second electrode 22 are heated to a predetermined temperature, such that the surroundings may be heated. The needle electrode 21a of the first electrode 21 may be heated. For example, the first electrode 21 and/or the second electrode 22 may be heated to 25 to 100 degrees Celsius. For example, the first electrode 21 and/or the second electrode 22 may be an electrically resistive metal and may receive a voltage to be heated like a resistive heater. In this case, based on a high voltage value for generating plasma, a resistance value may be set for setting a predetermined temperature of heat generated in the first electrode 21 and/or the second electrode 22.

In another example, a separate heater may heat the surroundings of the first electrode 21 and/or the second electrode 22. For example, the heater may be a sheath heater. For example, the heater may be electrically connected to the first electrode 21 to heat the first electrode 21. For example, the heater may be electrically connected to the second electrode 22 to heat the second electrode 22.

Accordingly, ozone generated during ionization may be removed, which will be described below.

Referring to FIGS. 6 and 7, the first electrode 210 and the second electrode 22 may have a wire-plate shape. The first electrode 210, formed between the respective second electrodes 22, may have a wire shape elongated in a longitudinal direction of the second electrode 22. The second electrode 22 may have a plate shape. The first electrode 210 may receive a high voltage, and the second electrode 22 may be opposite to the first electrode 210 to be grounded. Alternatively, the second electrode 22 may receive a high voltage, and the first electrode 210 may be opposite to the second electrode 22 to be grounded. If a voltage is applied to the first electrode 210 or the second electrode 22, discharge occurs in the vicinity of the first electrode 210 to form plasma. Accordingly, foreign matter may be ionized.

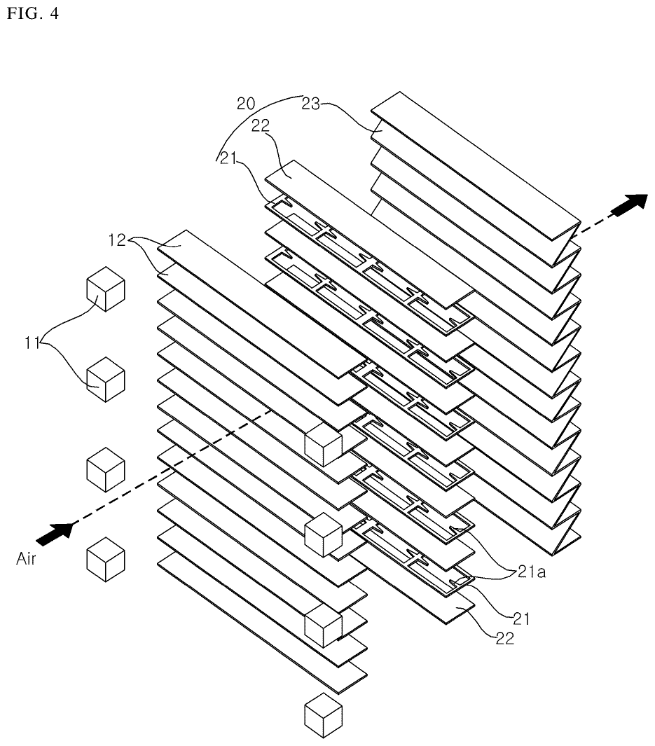

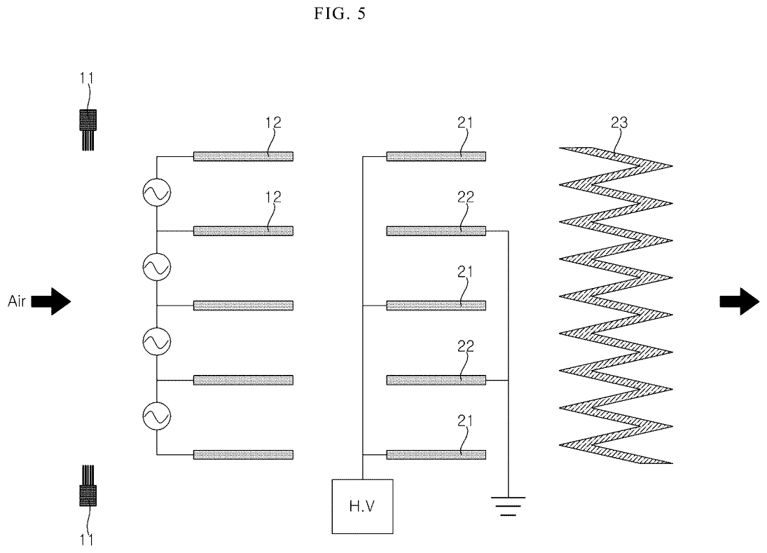

The first electrode 210 and the second electrode 22 may be heated, as described above with reference to FIGS. 4 and 5.

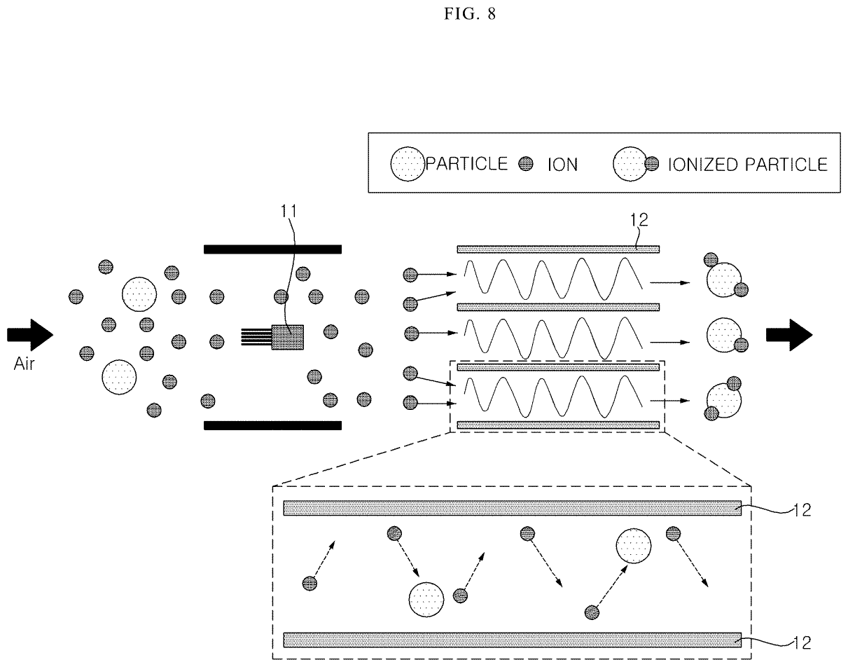

Referring to FIG. 8, particles, such as foreign substances and the like in air, may be electrically charged and ionized by the first charging unit 11. The charged particles and ions and uncharged particles may pass through the second charging unit 12 along with air.

The second charging unit 12 may generate an alternating current between a plurality of second charging units 12. That is, a potential difference between the second charging units that face each other may constantly change. The second charging unit 12 may alternatingly charge particles and ions in air. While passing through the plurality of second charging units 12, the particles and ions in the air may increase in speed due to the alternating current.

Accordingly, collision between the particles and/or ions may actively take place, behavior time may increase, and chances of contact between uncharged particles and ions may increase. Therefore, a charging rate of foreign particles may increase, and foreign matter collection efficiency may be improved.

After passing through the second charging unit 12, the air may pass through the dielectric filter 23. The charged particles may be physically collected in the dielectric filter 23 by electrostatic force.

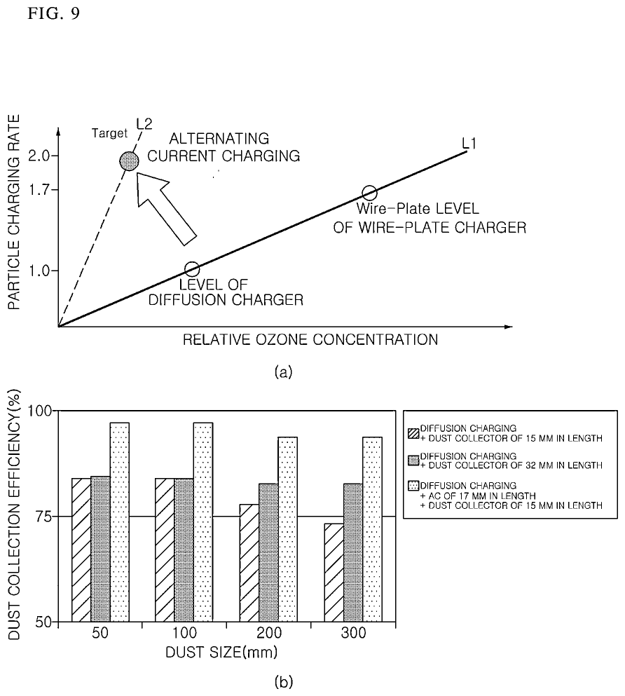

Referring to FIG. 9, FIG. 9 (a) illustrates comparison between a trend line L1, showing a relative concentration of the generated ozone with respect to a particle charging rate of a diffusion charger and a wire-plate charger, and a trend line L2 showing a relative concentration of the generated ozone with respect to a particle charging rate when alternating current charging is added. It can be confirmed that in the case where the alternating current charging is added, the concentration of the generated ozone is relatively lower compared to the particle charging rate.

FIG. 9 (b) illustrates comparison of dust collection efficiency in the cases where a dust collector section has lengths of 15 mm and 32 mm in an air flow direction and in the case where the alternating current (AC) charging unit having a length of 17 mm is added to a dust collector having a length of 15 mm. The diffusion charger is used in conjunction therewith in each comparison group. The dust collecting efficiency is calculated as a ratio of collected dust to the dust.

In the case where a dust size is 50 nm, the dust collector having a length of 15 mm exhibits a dust collection efficiency of 84%, the dust collector having a length of 32 mm exhibits a dust collection efficiency of 85%, and the dust collector with the AC charging unit added thereto exhibits a dust collection efficiency of 97%. As the dust size increases, a difference between the dust collection efficiencies increases more, such that the dust collection efficiency is much higher when the AC charging unit is added.

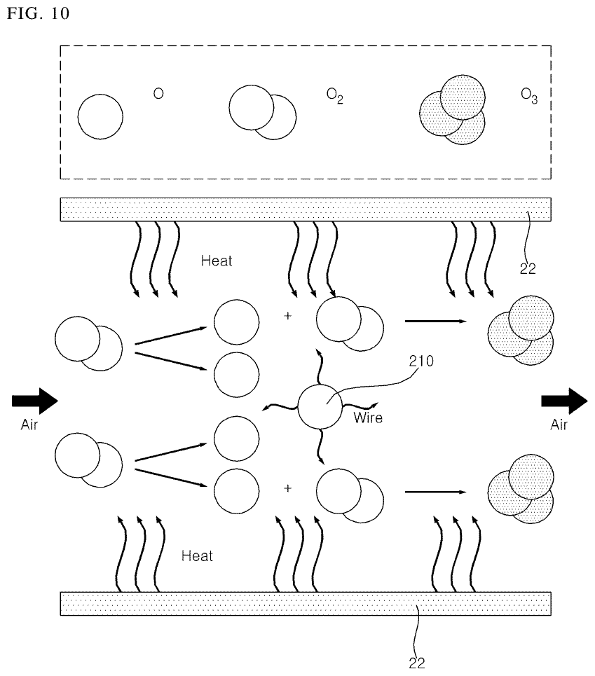

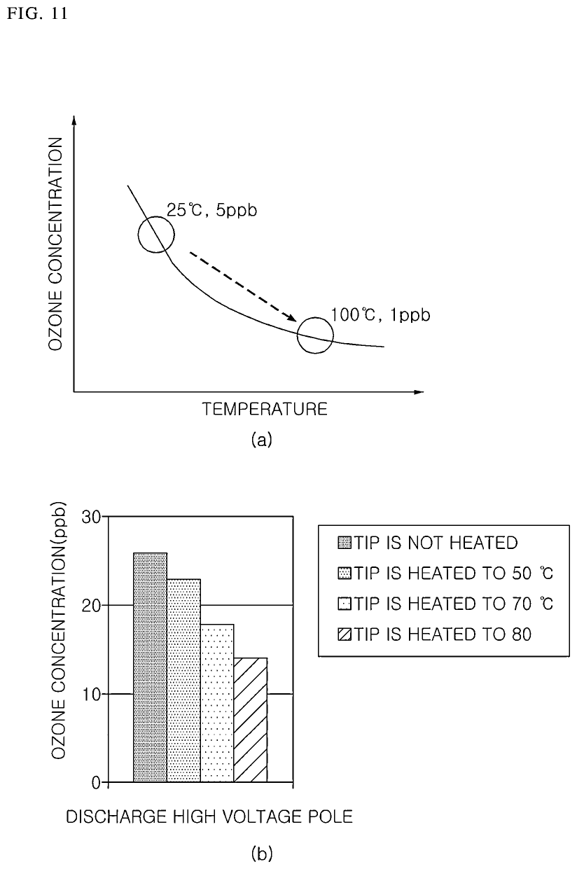

Referring to FIGS. 10 and 11, oxygen molecules (O2) in air are dissociated into oxygen atoms (O) by discharge, and the oxygen atoms (O) combine with oxygen molecules (O2) to create ozone (O3). In this case, the ozone concentration may be reduced by heating the surroundings of the first electrode 210 and the second electrode 22. For example, the heater may directly heat the surroundings of the electrodes as described above, or an electrically resistive electrode may be directly heated by receiving an electric current.

Referring to FIG. 11 (a), it can be confirmed that as the electrode temperature increases, the ambient ozone concentration decreases. Referring to FIG. 11 (b), it can be confirmed that as the electrode temperature increases, the ozone concentration decreases. As the electrode temperature increases, the dielectric breakdown strength of air decreases, and the discharge voltage falls, such that the ozone concentration may be reduced.

While the present disclosure has been particularly shown and described with reference to preferred embodiments thereof, it will be understood by those skilled in the art that the present disclosure is not limited to those exemplary embodiments and various changes in form and details may be made therein without departing from the scope and spirit of the disclosure as defined by the appended claims, and such modifications should not be individually understood from the technical spirit or prospect of the present disclosure.

1. An electric precipitator comprising:
a first charging unit configured to receive a first high voltage;
a second charging unit provided downstream of the first charging unit and configured to receive an alternating current; and
a dust collector disposed downstream of the second charging unit and configured to collect charged particles.

2. The electric precipitator of claim 1, wherein the second charging unit is formed as a plurality of electrode plates and arranged parallel to and separated from each other in a thickness direction by a first prescribed distance therebetween.

3. The electric precipitator of claim 2, further comprising a case having an opening in an air flow direction to accommodate the second charging unit and the dust collector,
wherein the first charging unit a plurality of protrusions disposed opposite edges of the case and facing the opening of the case.

4. The electric precipitator of claim 1, wherein the dust collector comprises: a plurality of first and second electrodes which are alternately arranged and separated by a second prescribed distance, the plurality of first electrodes configure to receive a second high voltage and the plurality of second electrodes are configured to be grounded.

5. The electric precipitator of claim 4, wherein the plurality of first electrodes includes a needle electrode having a pointed shape for generating a corona discharge upon receiving the second high voltage.

6. The electric precipitator of claim 4, wherein the plurality of first electrodes include an electrically resistive metal which is heated upon receiving the second high voltage.

7. The electric precipitator of claim 4, further comprising a heater configured to heat air around at least one of the first electrode or the second electrode.

8. The electric precipitator of claim 4, wherein air around at least one of the first electrode or the second electrode is heated to 25 to 100 degrees Celsius.

9. The electric precipitator of claim 3, wherein the dust collector further includes a filter disposed downstream of the plurality of first and second electrodes.

10. A home appliance having the electric precipitator of claim 1, the home appliance comprising:
a housing having an inlet and an outlet; and
a blower fan disposed in the housing and configured to cause the air to flow from the inlet to the outlet, wherein the electric precipitator is provided upstream of the blower.

11. The electric precipitator of claim 4, wherein the plurality of first electrodes is a wire type electrode.

12. An electric precipitator comprising:
a case having an opening;
a plurality of high voltage electrodes provided in front of the case;
a plurality of electrode plates provided in the opening of the case, the electrode plates being arranged parallel to and separated from each other by a first prescribed distance and configured to receive an alternating current;
a plurality of first and second electrodes provided in the opening of the cases, wherein the plurality of electrode plates is provided between the high voltage electrodes and the plurality of first and second electrodes; and
a filter is provided downstream of the plurality of first and second electrodes.

13. The electric precipitator of claim 12, wherein the plurality of high voltage electrodes comprises protrusions provided on opposites sides of the case, the protrusions configured to receive a first high voltage.

14. The electric precipitator of claim 12, wherein the first and second electrodes are parallel to each other and alternately arranged, adjacent first and second electrodes being separated by a second prescribed distance, and the plurality of electrode plates and the plurality of first and second electrodes are arranged in parallel in a width direction of the case.

15. The electric precipitator of claim 12, wherein at least one of the first electrodes or the second electrodes are heated to 25 to 100 degrees Celsius.

16. The electric precipitator of claim 12, wherein the first electrodes are configured to receive a second high voltage and the second electrodes are configured to be grounded.

17. The electric precipitator of claim 12, wherein at least one of the first electrodes or the second electrodes includes a needle electrode having a pointed shape.

18. The electric precipitator of claim 12, wherein at least one of the first electrodes or the second electrodes is a wire type electrode.

19. The electric precipitator of claim 12 further comprising a heater configured to heat air around at least one of the first electrodes or the second electrodes.

20. The electric precipitator of claim 12, wherein at least one of the first electrodes or the second electrodes includes an electrically resistive metal for heat generation upon receiving a voltage.
